(19) United States
(12) Patent Application Publication
(10) Pub. No.: US 2009/0157654 A1
(43) Pub. Date: Jun. 18, 2009

(54) System and method for presenting mixed media

(76) Inventors: Chen-Hwa Song, Taipei (TW); Wen-Hsi Yeh, Taipei (TW); Chin-Ta Lin, Hsinchu (TW); Shih-Fang Chang, Taoyuan (TW); Ko-Hsuan Chang, Taipei (TW); Yi-Jen Yeh, Miaoli (TW)

Correspondence Address: LIN & ASSOCIATES INTELLECTUAL PROPERTY, INC., P.O. BOX 2339, SARATOGA, CA, 95070-0339, US

(21) Appl. No.: 12/053,540

(22) Filed: Mar. 21, 2008

Related U.S. Application Data
(60) Provisional application No. 61/012,926, filed on Dec. 12, 2007.

(51) Int. Cl. G06F 17/30

(52) U.S. Cl. 707/5; 707/E17.056

(57) ABSTRACT

Disclosed is directed to a system and method for presenting mixed media. The system at least comprises location component, time component, and event component. Event component provides specified records or incidents. Location component provides specified places or areas. Time component provides specified time or time intervals. Disclosed embodiments create the multi-dimensional information retrieval, which is useful for user to obtain the relevant location and time while inquiring about a specific interesting event. Disclosed embodiments also present the interaction and relation of multi-dimensional information retrieval.

### FIELD OF THE INVENTION

The present invention relates to a system and method for presenting mixed media, which integrate map and time-line with multimedia blogs or any communication platforms.

### BACKGROUND OF THE INVENTION

In recent technologies, blogs or any communication platforms appear in a large amount like the mushrooms after rain, developing constantly. Moreover, a blog is read publicly and supports the functionality of multimedia. The blog may contain text, image or multimedia. The characteristic of public has established the foundation that blog advocated being shared. Most of the web-services, including blog-related websites, utilize the one-dimensional or two-dimensional query, such as Google Search, WordPress.com, etc. For example, Google uses the one-dimensional query. After a user inputs one or more keywords, the user may get as many as ten thousand web-pages which contain a wide variety of topics for the keywords. Similarly, WordPress.com, using the one-dimensional query, a user may get a set of events which contain tags after the user pick the topics being discussed.

Most of hot blogs contain a large number of personal articles and multimedia, such as YouTube and ABC News. Furthermore, someone begins to think how to put other applications into blogs, and this may be referred to as the two-dimensional query. For instance, Atlaspost allows blogs to get in on the concept of space, combining Google Maps service. A user could set up the position in the map of place that one's own blog or articles described, search specific incident directed a certain specific area at the map, or use the square frame to search in order to obtain all events in its result in the map.

Nevertheless, a website using the one-dimensional or two-dimensional query is limited to the inquiry. One current approach at so-called Simile website offers the service of Timeline, and a user could drag it for the sake of browsing all events on the Timeline. In the current websites, there is no application that has employed the three-dimensional query yet, in which the three-dimensional query may allow a user to integrate the concept of time with blog, map, or both of them.

### SUMMARY OF THE INVENTION

In accordance with the exemplary embodiments of the present invention, the disclosed may provide a system and method for presenting mixed media.

In an exemplary embodiment, the disclosed is directed to a system for presenting mixed media, comprising a location component, a time component, and an event component. Event component provides specified records or incidents. Location component provides specified places or areas. Time component provides specified time or time intervals.

In another exemplary embodiment, the disclosed is directed to a method for presenting mixed media, comprising: performing multi-dimensional information retrieval with one or more multimedia blogs or communication platforms; and making up a three-dimensional query of at least a combination of event, location and time for an associated multi-dimensional information retrieval.

Disclosed embodiments may create the multi-dimensional information retrieval and the multi-dimensional query, which will be useful for users to obtain the relevant location information and time information while inquiring about a specific interesting event. Disclosed embodiments also present the interaction and relation of the multi-dimensional information retrieval and the multi-dimensional query.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematically diagram that illustrates an exemplary three-dimensional information retrieval, consistent with certain embodiments of the present disclosure.

FIG. 2A shows a schematically diagram that illustrates an exemplary three-dimensional layout of a system for presenting mixed media, consistent with certain embodiments of the present disclosure.

FIG. 2B shows a schematically diagram that illustrates another exemplary three-dimensional layout of a system for presenting mixed media, consistent with certain embodiments of the present disclosure.

FIG. 3 shows a schematically diagram that illustrates an exemplary event component, consistent with certain embodiments of the present disclosure.

FIG. 4 shows a schematically diagram that illustrates an exemplary location component, consistent with certain embodiments of the present disclosure.

FIG. 5 shows a schematically diagram that illustrates an exemplary time component, consistent with certain embodiments of the present disclosure.

FIG. 6 shows an exemplary flow diagram illustrating the functions that server supports, consistent with certain embodiments of the present disclosure.

FIG. 7 shows an exemplary flow diagram illustrating the multi-dimensional search of events, consistent with certain embodiments of the present disclosure.

FIGS. 8A-8E illustrates an exemplary execution by reference to FIG. 1 for displaying multi-dimensional query, consistent with certain embodiments of the present disclosure.

FIG. 9 shows an exemplary sequence diagram that schematically illustrates the multi-dimensional search of events, and the corresponding procedure of communication between every component of the system for presenting mixed media, consistent with certain embodiments of the present disclosure.

FIG. 10 shows an exemplary sequence diagram that schematically illustrates events viewed, and the corresponding procedure of communication between every component of the system for presenting mixed media, consistent with certain embodiments of the present disclosure.

FIG. 11 shows an exemplary sequence diagram that schematically illustrates events clicked, and the corresponding procedure of communication between every component of the system for presenting mixed media, consistent with certain embodiments of the present disclosure.

FIG. 12 shows an exemplary flow diagram that schematically illustrates the flow path of a new event added and the flow path of an event edited, consistent with certain embodiments of the present disclosure.

FIG. 13 shows an exemplary sequence diagram that schematically illustrates a new event added and an event edited, and the corresponding procedure of communication between every component of the system for presenting mixed media, consistent with certain embodiments of the present disclosure.

### DETAILED DESCRIPTION OF THE PREFERRED EMBODIMENTS

Exemplary embodiments of the present invention may provide a solution to content accumulation and retrieval in multi-dimensional space to reach a set of events indexed by location and time. Such a combination of map, time-line with blog forms the three-dimensional query. In the three-dimensional query, the relation of events is not only moving on the two-dimensional level but also on the three or more dimensional levels, and actually matching the multi-dimensional space fusion. When an event happens, it may happen in some locations and stored on some time points or some time blocks; When lying in one area, it may have a lot of events stored in the past, now or future; When spying on one time point or one time block, it may discover that many events will take place on different locations.

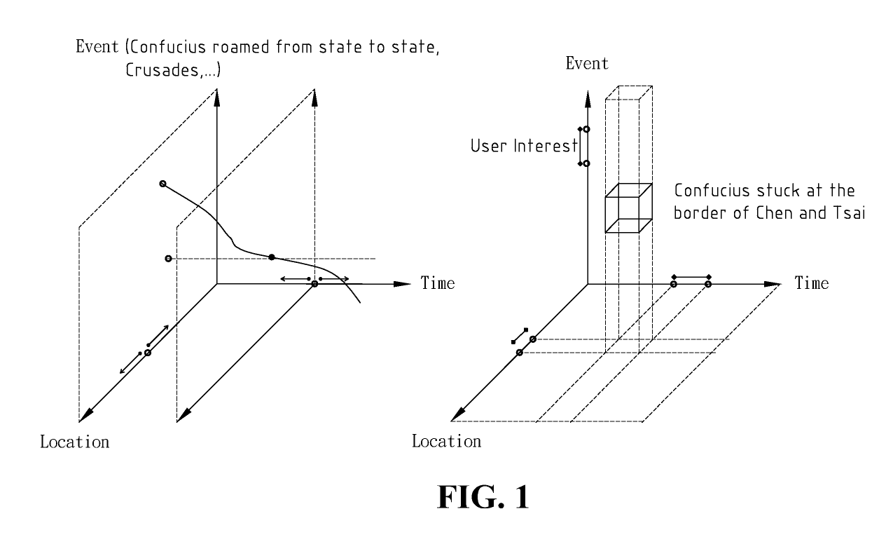

In the exemplary embodiments, the present invention employs multi-dimensional information retrieval. That is, a great deal of events across different locations, and have a wide time span. FIG. 1 shows a schematically diagram that illustrates an exemplary three-dimensional information retrieval, consistent with certain embodiments of the present disclosure. In the FIG. 1, event, time, and location have composed the three-dimensional vector quantities. A set of events may be person, object, or subject, and a user may query about an event first in accordance with the personal interest and narrow the range on the event axis as well as do the query of the location to the range in front and narrow it again on the location axis. Like doing this, it has already formed the traditional method of two-dimensional query. If the user joins a time vector together with two-dimensional level, and make an advanced inquiry and adjustment of time to the result of two-dimensional query, the user will receive the result of three-dimensional query finally.

For example, a user uses the multi-dimensional information retrieval on history search—“Confucius roamed from state to state”. If the user is interested in the event of Confucius stuck at the border of Chen and Tsai, once the user specifies the location and time of this event, the user may easily find other events in the same three-dimensional spaces.

Elaborate on the significance of three axis of dimensional vector. The relative distance on the time axis may represent the difference in time directly. However, both the location axis and the event axis belong to the abstract concept. The relative point on the location axis is the distance relation between two objects, and it gets rid of direction and height. The relative position on another event axis may vary with each individual. In other words, the relative distance on the event axis is the relative distance of both events, and the relative distance of both events will be different in terms of personal interest or individual experience. The relative distance between two events will bring the variation on different points in the time axis or the location axis, besides influence of the individual factor.

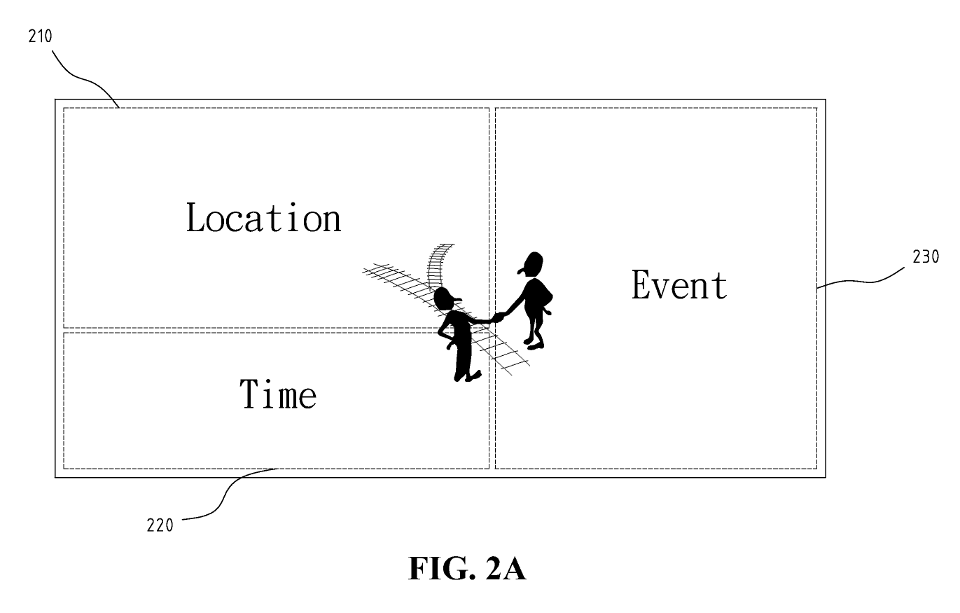

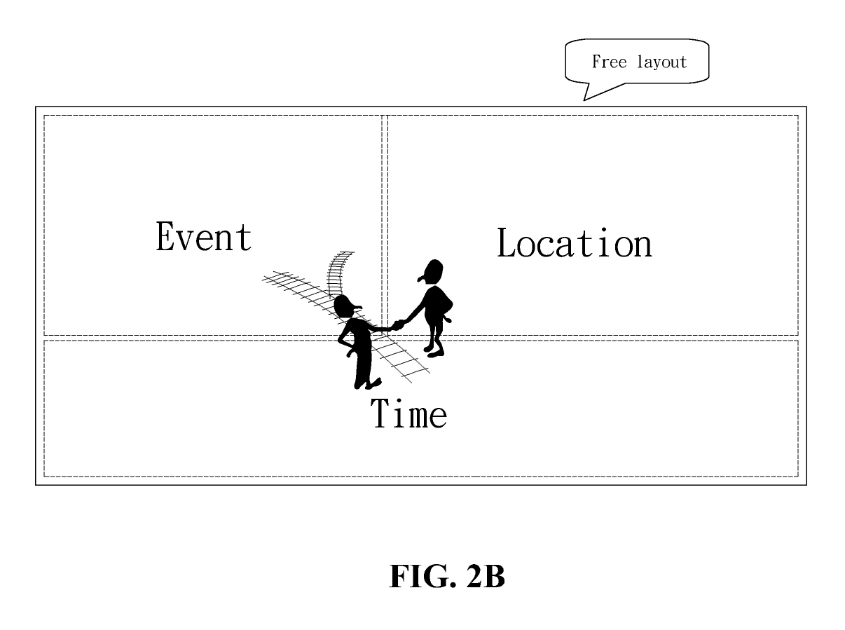

The present disclosure has performed the concept of multi-dimensional information retrieval actually, and then it will interpret it in the view of technique. As the description above, a three-dimensional query may be made up of at least a combination of event, location and time for an associated multi-dimensional information retrieval. Therefore, a website may consist of at least three components. Each component may be implemented by any combination of frame, division, area, block, tab, slide, and so forth. FIG. 2A shows a schematically diagram that illustrates an exemplary three-dimensional layout of a system for presenting mixed media, consistent with certain embodiments of the present disclosure. Referring to the exemplary three-dimensional layout shown in FIG. 2A, the upper-left part is the location component 210, the lower-left part is the time component 220 and the right part is the event component 230. Certainly, the relation of arrangement among the location component, time component and event component is untrammeled. For instance, FIG. 2B demonstrates another exemplary three-dimensional layout of a system for presenting mixed media, consistent with certain embodiments of the present disclosure.

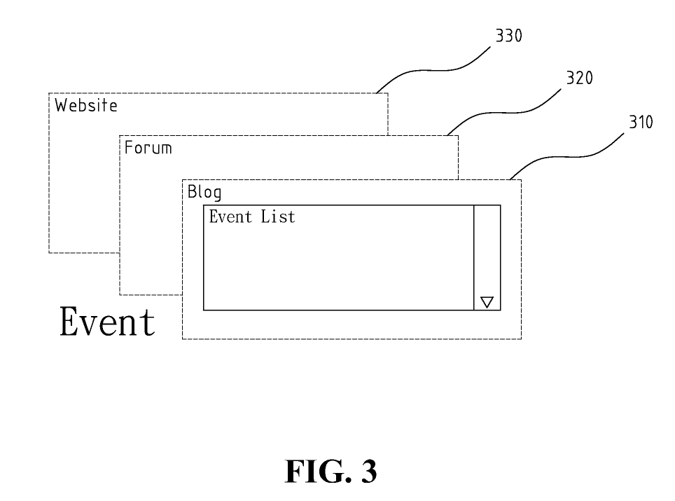

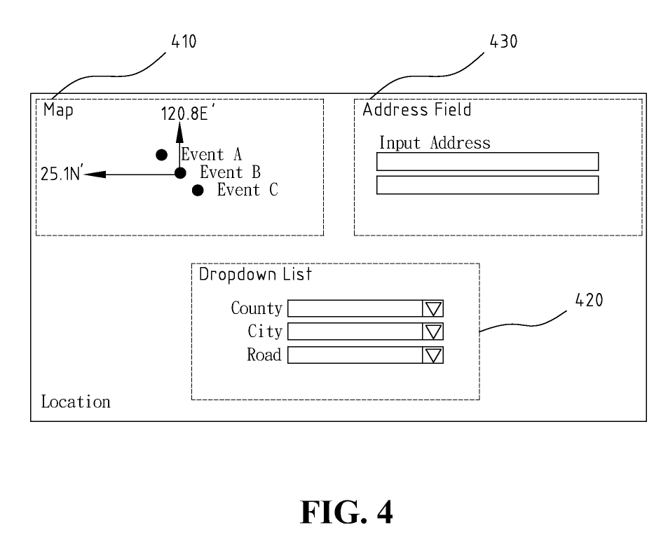

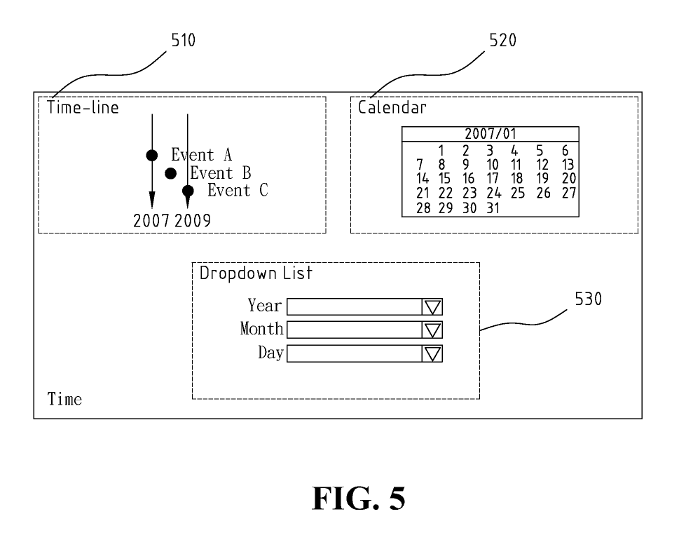

Event component consists of a set of event entries that provide specified records or incidents. For example, specified records or incidents may be someone's life story, records of something, or description of some articles. Event component may be presented by blog 310, forum 320, website 330, and so forth, as shown in FIG. 3. Location component consists of a set of location entries that provide specified places or areas. For example, specified places or areas may be some positions where a set of events happened. Location component may be presented by map 410, dropdown list 420, address field 430, and so forth, as shown in FIG. 4. Time component consists of a set of time entries that provide specified time or time intervals. For example, specified time or time intervals may be some time intervals when some events happened, start date when some events happened in the beginning, or end date when some events happened in the end. Time component may be presented by time-line 510, calendar 520, dropdown list 530, and so forth, as shown in FIG. 5. For example, the disclosed embodiments may use blog to implement event component, use map to implement location component, and use time-line to implement time component.

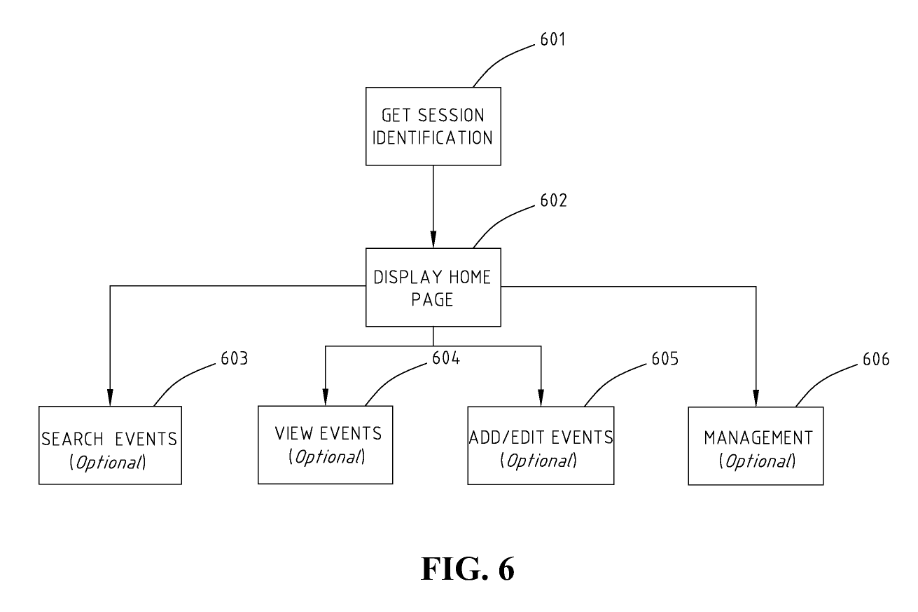

FIG. 6 shows an exemplary flow diagram illustrating the functions that a server supports, consistent with certain embodiments of the present disclosure. As shown in the steps 601-606 of FIG. 6, when a server that the system for presenting mixed media is associated with is getting session identification of clients, it would display home page and support any combination of event search, event view, and event addition/edited. Steps 603-606 may be optional.

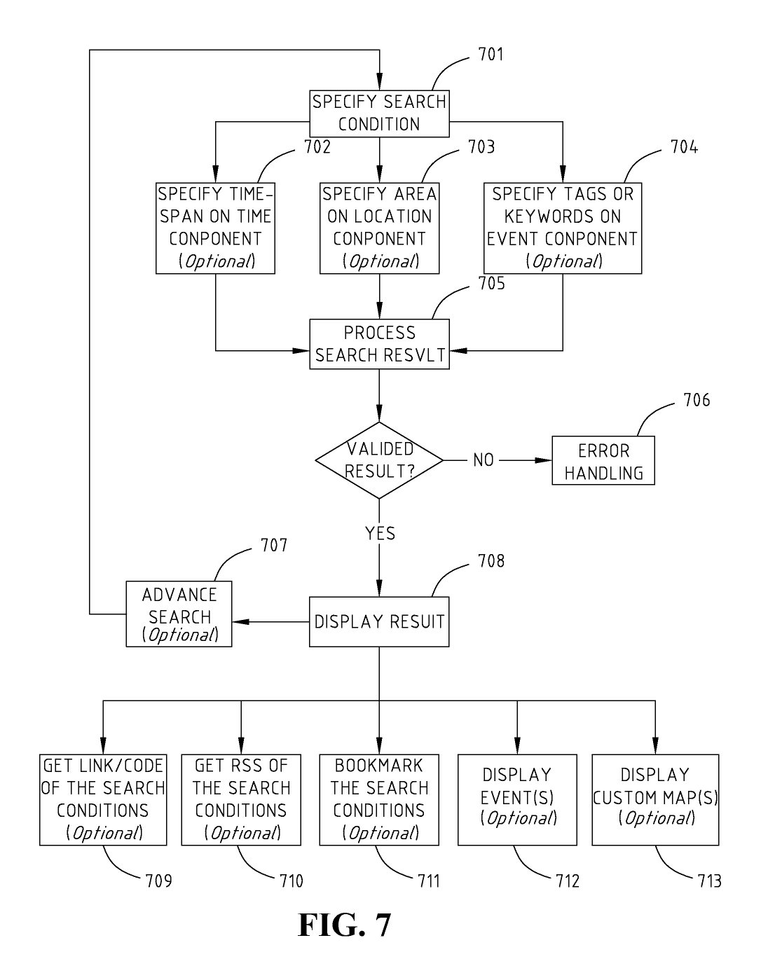

FIG. 7 shows an exemplary flow diagram illustrating the multi-dimensional search of events, consistent with certain embodiments of the present disclosure. Referring to the exemplary flow diagram shown in the steps 701-713 of FIG. 7, a user may specify time-span on time component (step 702), and/or specify area on location component (step 703), and/or specify tags or keywords on event component (step 704). After one search criterion has been specified, it is to process search result (step 705). If the search result is valid, then it displays the search result (step 708); otherwise, error handling will be performed (step 706). The steps 707 of advance search and 709-713 which follows the step 708 may be optional. For example, get link/code of the search conditions (step 709) or get rss of the search conditions (step 710) or bookmark the search conditions (step 711) or display event(s) (step 712) or the steps of display custom maps (step 713) may or may not be necessary. It just depends on the client's need.

There may be several kinds of method in querying about a set of events on blogs. For example, a user may input text or keywords to carry on searching events which may include words, and the user may select tags or tag clouds to classify and compare events. Then, the user may execute the analysis of events or data mining according to the personal interest, profile, or historical data.

There may be several kinds of method for searching on map as well. For example, a user may drag the map to have a look around the sign of events on the map. If the user would like to scrutinize the content of events, the user may click pins on the map. The user may further use the search box to query about all events of the specific area on the map.

Querying on time-line or querying on map is similar to searching on map. For example, a user may drag the time-line to surf the mark of events on time-line, and the user may click the time line to look over the content of events. Besides, time-line may be replaced by time block to conduct a search, and all events are demonstrated on the time block.

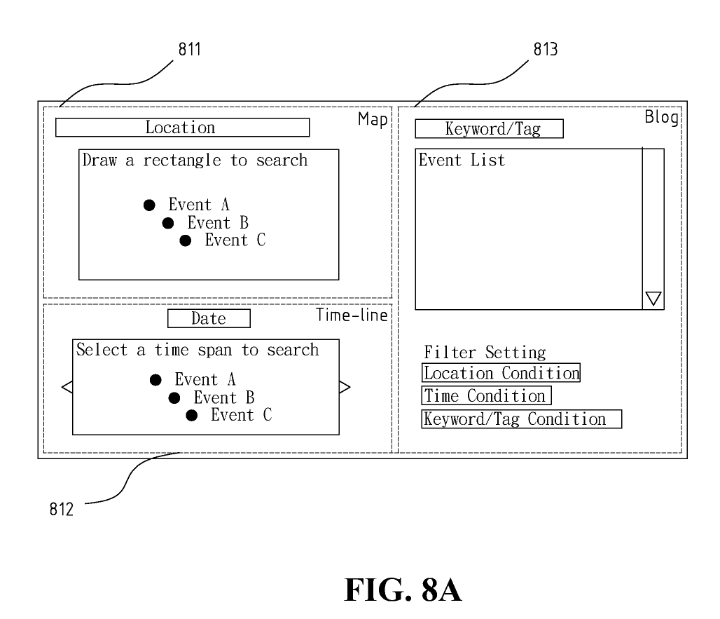

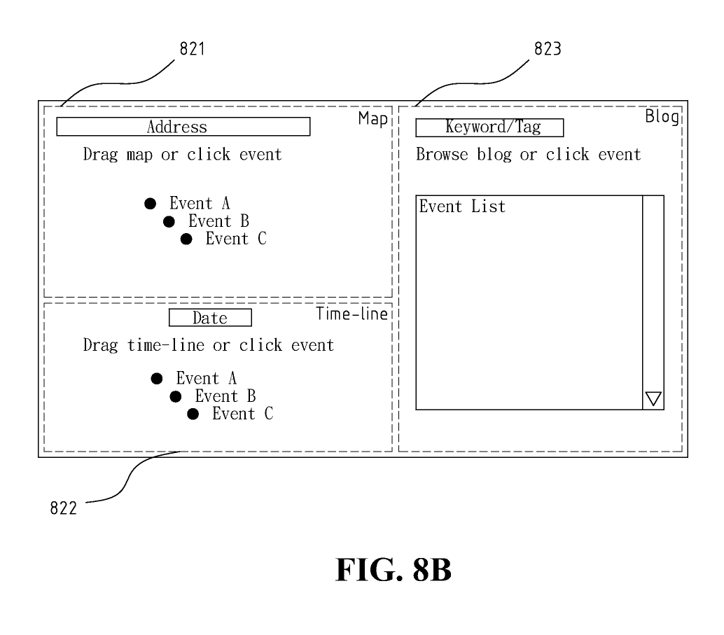

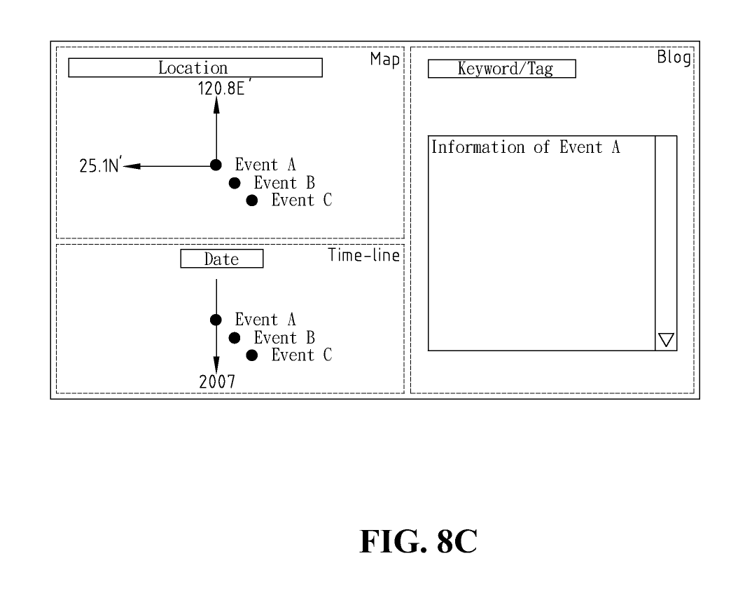

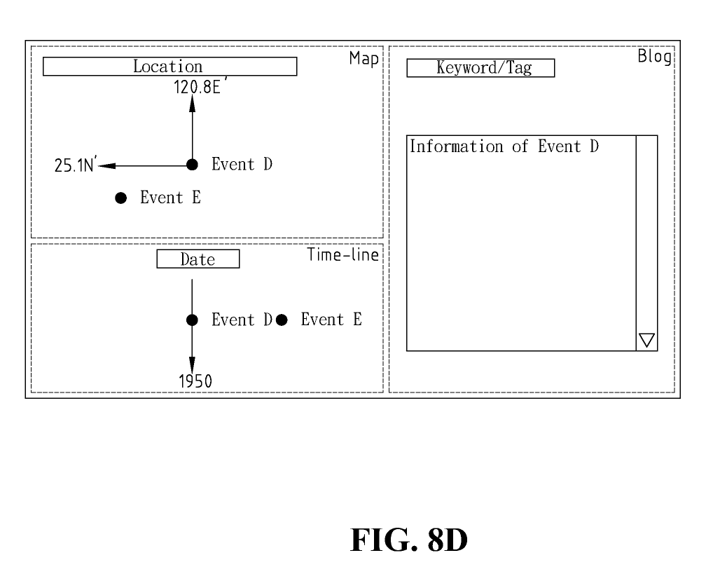

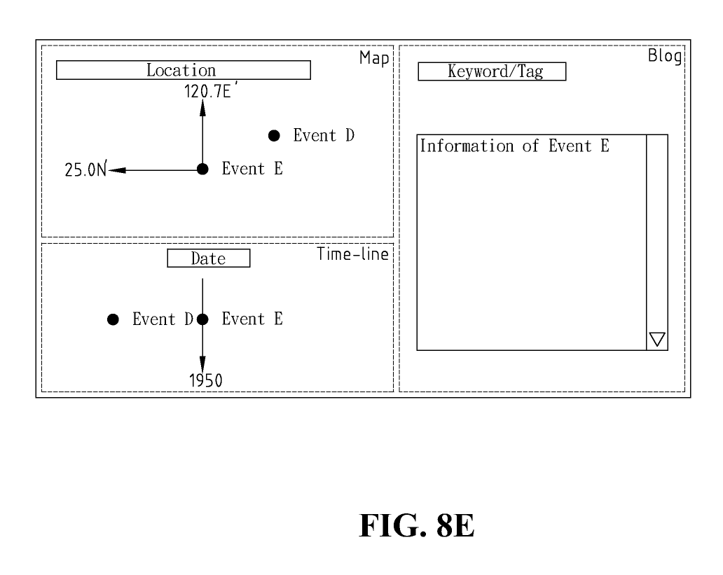

Some working examples existing in a set of events indexed by location and time are demonstrated to state in more detail for the multi-dimensional information retrieval. FIGS. 8A-8E illustrates an exemplary execution by reference to FIG. 1 for displaying multi-dimensional query, consistent with certain embodiments of the present disclosure. In the example of FIG. 8A which is shown about searching events, a user may search for events by drawing a rectangle on the location component (such as map 811), selecting a time-span on time component (such as time-line 812), and/or inputting tags on event component (such as blog 813), the search results will be displayed on an event frame. The user may further filter the displayed result by using the search box, time block, or tags again. The filtered search result will be shown on the event frame and may be arranged in order according to specified time slots or locations.

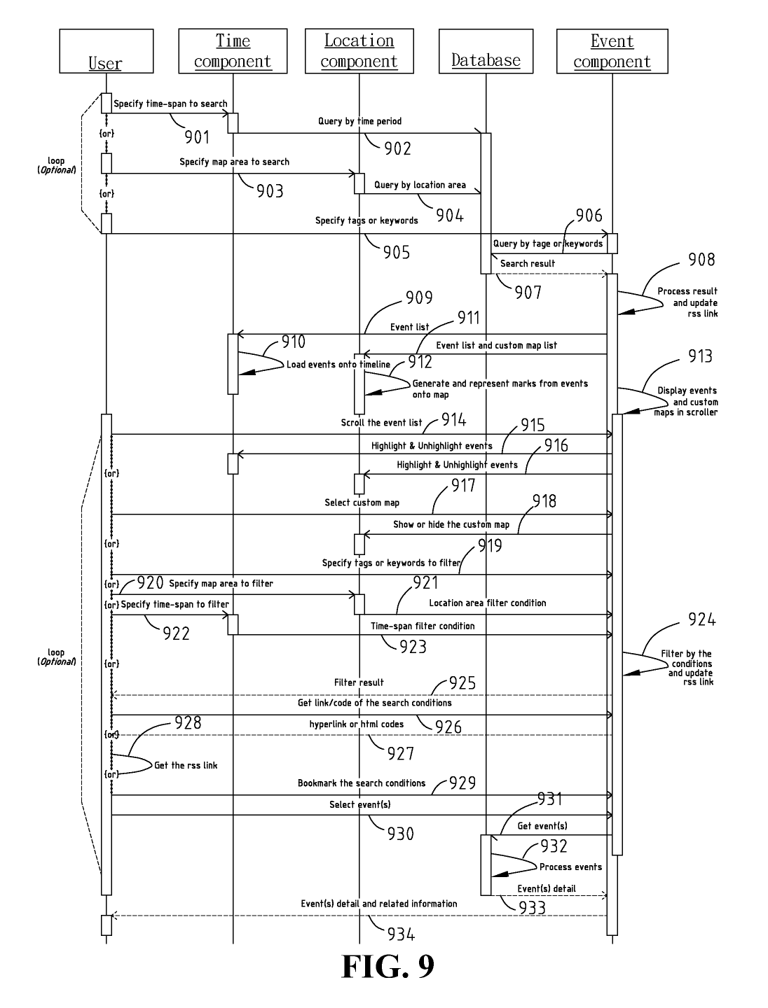

FIG. 9 shows an exemplary sequence diagram that schematically illustrates the multi-dimensional search of events, and the corresponding procedure of communication between every component of the system for presenting mixed media, consistent with certain embodiments of the present disclosure. Steps 901-934 describe each corresponding exemplary procedure of communication between every component, respectively.

In the exemplary sequence diagram of FIG. 9, a user may optionally choose the way of event search as described in FIG. 8A and respectively labeled by steps 901-906 in FIG. 9. For example, if the user selects a specified time-span and queries by a time period to search events (steps 901 and 902), the search result may be send to time component, location component, and event component. For example, the search result is sent to event component (step 907), a searched event list is sent to time component (step 909) and loaded events onto time-line (step 910), and a searched event list and an associate map list are sent to location component (step 911) and generated and represented marks from events onto map (step 912).

After a set of searched events have been generated, the user may scroll the event list (step 914), or select custom map (step 917), or further filter the searched events, such as shown in steps 919-923. For example, the user may specify map area to filter (step 920) on location component and send the location area filter condition to event component (step 921) for further filtering the searched events. Steps 915 and 916 are some working examples that the user may scroll the event list. Step 918 is a working example that the user may select custom map.

After filtering by conditions, the rss link may be updated and the filtered result will be sent the user, as shown in steps 924 and 925 respectively. Besides, as mentioned earlier (i.e. in FIG. 7), the user may get link/code of the search conditions, or get rss link, or bookmark the search conditions, or display event(s). Steps 926-934 illustrate such optional actions of the user in more detailed. For example, the user may select events through event component (step 930) for display. The event component gets the selected events from database (step 931). After having processed the selected events (step 932), the events with detailed information will be sent to event component (step 933). The events with detailed and related information will be further sent to the user from event component (step 934).

As shown in FIG. 9 and mentioned above, loop for specifying time-span to search (step 901) or specifying map area to search (step 903) or specifying tags or keywords (step 905) may be optional. Loop for steps 914-934 may be optional too.

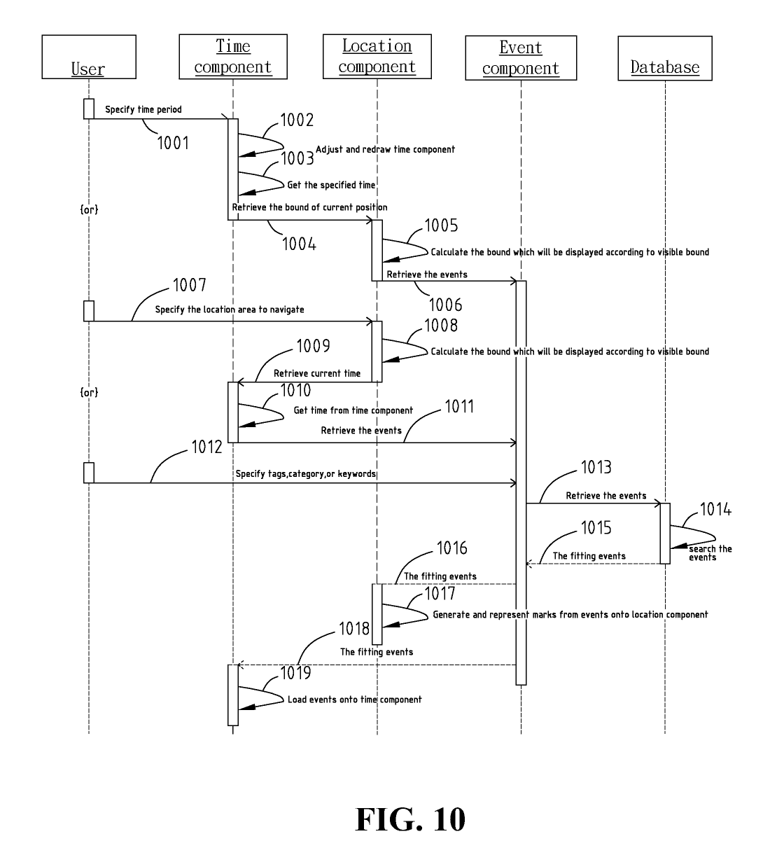

In the example of FIG. 8B which is shown about viewing events, a user may drag map or click event on location component (such as map 821), drag time-line or click event on time component (such as time-line 822), and browse blog or click event on event component (such as blog 823). FIG. 10 shows an exemplary sequence diagram that schematically illustrates events viewed, and the corresponding procedure of communication between every component of the system for presenting mixed media, consistent with certain embodiments of the present disclosure. Steps 1001-1019 describe each corresponding procedure of communication between every component, respectively.

For example, a user may specify a time period (step 1001) to adjust and redraw time component (step 1002), then the user may get the specified time on time component (step 1003). Because the user does not specify a location, time component will notify location component to retrieve the bound of current position (step 1004). After location component calculates the bound which will be displayed according to a visible bound (step 1005), location component will notify event component to retrieve the events (step 1006) for display. Similarly, a user may specify a location on location component to navigate (step 1007) and location component will calculate the bound which will be displayed according to a visible bound (step 1008). Location component will notify time component to retrieve current time (step 1009) and get time from time component (step 1010). Event component will be notified to retrieve the events (step 1011) for display.

If the user specify tags, or category, or keywords on event component (step 1012), event component will retrieve the events from database (step 1013). The searched events or the events after filtering will be sent to event component and further sent to location component via event component, as shown in steps 1014-1017. The searched events or the events after filtering will be further sent to time component (step 1018), and the events will be loaded onto time component (step 1019).

As shown in FIG. 10 and mentioned above, after a user drags map or time-line, or browses blog, both time-line and map may be adjusted and redrawn, and blogs will be reloaded information of corresponding events.

In the example of FIG. 8C, a user clicks the Event A on a blog, the blog will pop out the information page of Event A. The information page of Event A, for example, may indicate that it got renamed from Event D in 1950. With the function of automatic adjustment of location and time, the user may click on the link of Event A for further information. As shown in the example of FIG. 8D, if scrolling time-line backward, the user may discover that the pin-mark on map has changed to Event D from Event A. When the user clicks the pin-mark on the map, the text content of Event D in 1950 will be displayed on the blog. At the same time, the center of the map will move to the location where Event D takes place.

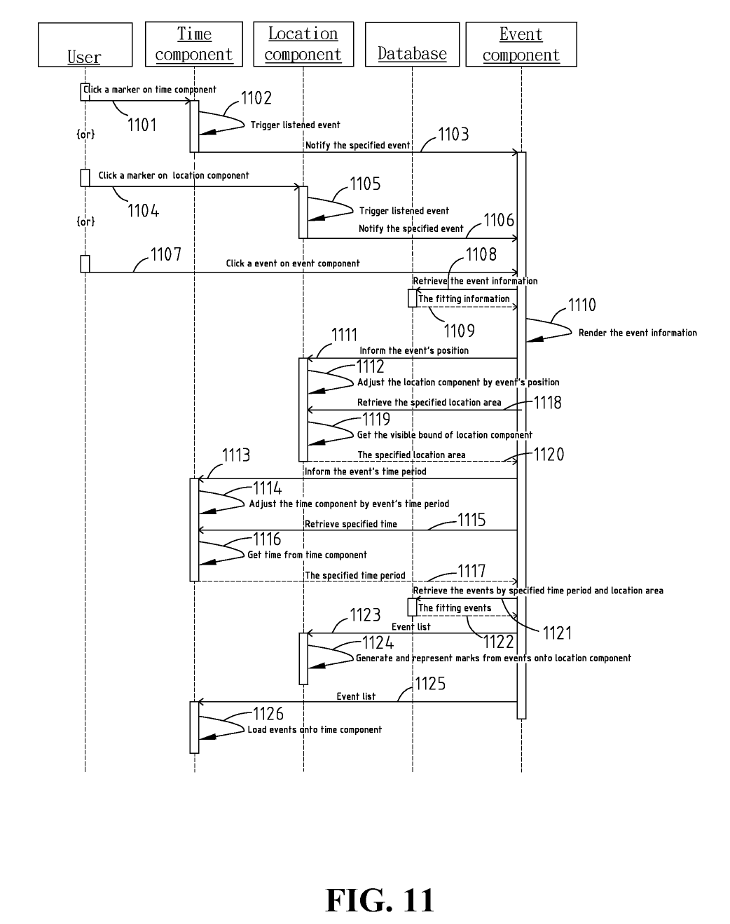

FIG. 11 shows an exemplary sequence diagram that schematically illustrates events clicked, and the corresponding procedure of communication between every component of the system for presenting mixed media, consistent with certain embodiments of the present disclosure. Steps 1101-1126 describe each corresponding procedure of communication between every component, respectively in the exemplary sequence diagram of FIG. 11.

For example, a user may click a marker on time component (step 1101) or location component (step 1104), and time component or location component will trigger listened events (step 1102 or step 1105) and notify a specified event to event component (step 1103 or step 1106). Similarly, if the user clicks an event on event component (step 1107), event component will retrieve the event information from database (step 1108) and filtering information will be sent to event component (step 1109). Event component renders the event information (step 1110) and informs location component of the event's information (step 1111). After the location component being adjusted by the event's information, event component retrieves a specified location from location component (step 1112) and gets the visible bound of location component (step 1118). The specified location is further sent to event component (step 1120).

After the location component is adjusted by the event's information, i.e. step 1112, event component inform location component of the event's time period (step 1113). After time component is adjusted by the event's time period (step 1114), event component retrieves a specified location from time component (step 1115) and gets time from time component (step 1116). The specified time period is further sent to event component (step 1117). Event component retrieves events from database by the specified time period and location area (step 1121). The filtering events are sent to event component from database (step 1122). An event list will be further sent to location component from event component (step 1123), thereby generating and representing marks from events onto location component (step 1124). This event list will be also sent to time component (step 1125) for loading events onto time component (step 1126).

Therefore, after a user click a pin-mark on the map, or click a mark on time-line, or click a link on the blog, the center of the map will shift to the corresponding event's position, the center of time-line will be set to the corresponding event's start date, and the blog will present the corresponding event's information.

In the example of FIG. 8D, a user notices that there is an upcoming event on the time component and clicks on the upcoming event to link to Event E. Then, the information of Event E will be presented on the event component, and the center of the location component will move to the location where Event E takes place, as shown in FIG. 8E.

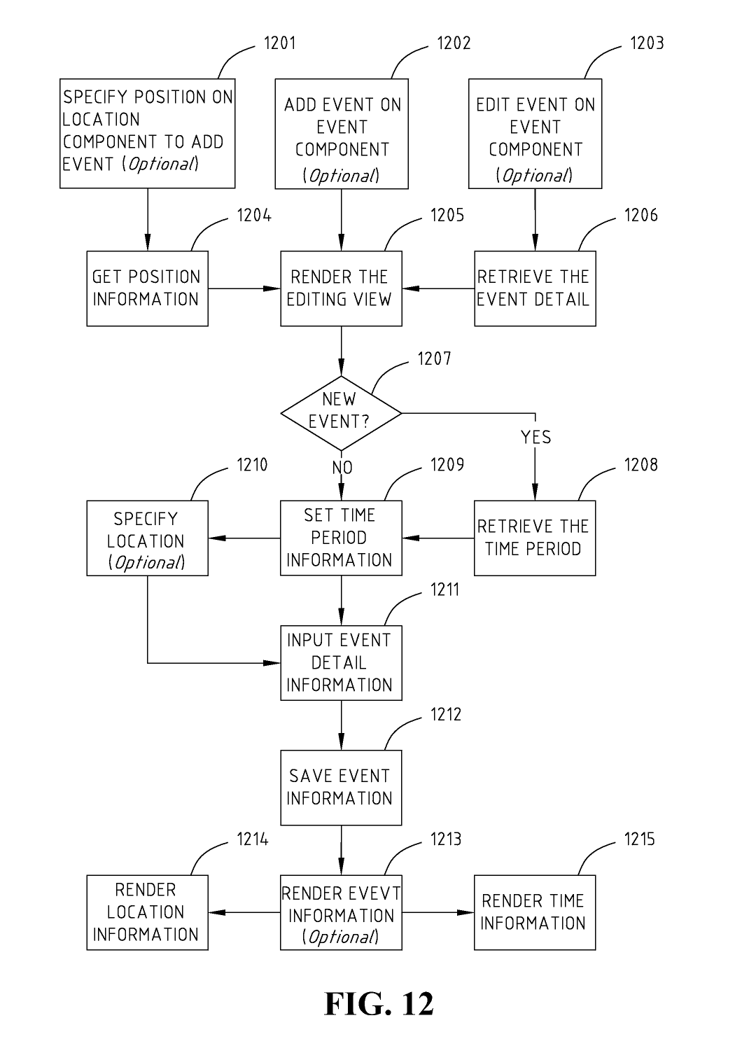

Besides the searching and viewing of events, a user may also add a new event, or edit an event. FIG. 12 shows an exemplary flow diagram that schematically illustrates the flow path of a new event added and the flow path of an event edited, consistent with certain embodiments of the present disclosure. Steps 1201-1215 illustrate the corresponding flow path, respectively.

Referring to the exemplary flow diagram shown in the steps 1201-1215 of FIG. 12, a user may specify position on location component to add an event (step 1201), and/or add an event on event component (step 1202), and/or edit an event on event component (step 1203). If the user specifies a position on location component to add an event, the user will get position information (step 1204) and render the editing view (step 1205). If the user adds an event on event component, the user will render the editing view (step 1205). If the user edits an event on event component, the user will retrieve the event detail (step 1206) and render the editing view (step 1205). After rendering the editing view (step 1205), whether the added event is a new event will be checked (step (1207). If the added event is not a new event, the time period corresponding to the added event will be retrieved (step 1208) and set (step 1209). Otherwise, the time period corresponding to the added event will be directly set.

After setting the time period, event detail information will be inputted and saved, as shown in step 1211 and step 1212 respectively. Before inputting event detail information, the location corresponding to the added event may be specified (step 1210). After saving event detail information, time information and location information corresponding to the added event will be rendered, as shown in step 1215 and step 1214 respectively, and whether rendering the event information corresponding to the added event is optional, as shown in step 1213.

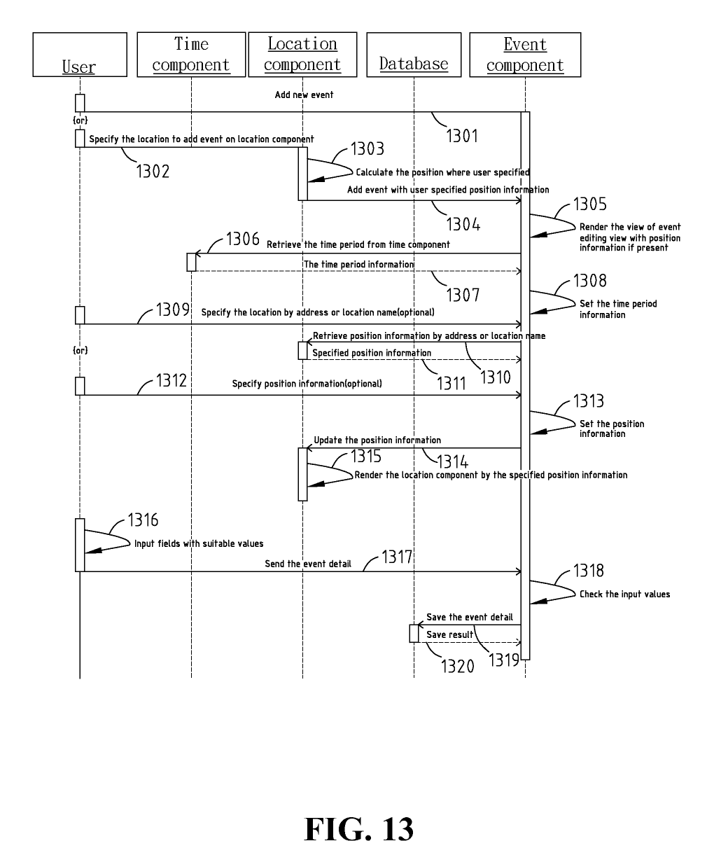

FIG. 13 shows an exemplary sequence diagram that schematically illustrates a new event added and an event edited, and the corresponding procedure of communication between every component of the system for presenting mixed media, consistent with certain embodiments of the present disclosure. Steps 1301-1320 illustrate the corresponding procedure, respectively.

Referring to the exemplary sequence diagram of FIG. 13, a user may adds a new event on event component (step 1301) or specify a location on location component to add an event (step 1302). Location component will calculate the specified position (step 1303) and notify event component to add the event with the specified position information (step 1304). Event component will render the view with the specified position information if the view presents on the event editing view (step 1305). Event component will retrieve the time period corresponding to the added event from time component (step 1306), and time component will send the time period to event component (step 1307). After event component having set the time period information (step 1308), the user may specify the location by address or location name (step 1309) on event component. Step 1309 may be optional. Event component may retrieve position information by address or location name from location component (step 1310), and location component sends the position information to event component (step 1311).

As indicated in step 1312, the user may specify the position information on event component. This step is optional. After event component having set the position information (step 1313), it notifies location component to update the position information (step 1314), thereby rendering location component by the specified position information (step 1315). The user may input event detail information with suitable values in input fields (step 1316), and send the event detail information to event component (step 1317). Event component checks the input values (step 1318) and saves the event detail information into database (step 1319). The saved result may be sent to event component (step 1320) for display. This step is also optional.

Therefore, when a user add a new event on the event component or specify a location to add an event on the location component, the location component will calculate the position where the user specified, and send the position information to the event component, and time component will send the time information to the event component.

In summary, the system and method for presenting mixed media according to the present invention may create the techniques of multi-dimensional information retrieval, which has broken the limitation of the two-dimensional query. The present invention may provide a three-dimensional interface, including event axis, location axis, and time axis. It may also present the interaction and relation of multi-dimensional information retrieval. The present invention may support many kinds of new behavior for browsing websites, and it will give users more freedom and better user experiences in surfing on the cyberspace.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system for presenting mixed media, which performs multi-dimensional information retrieval with one or more multimedia blogs or communication platforms, said system at least comprising:
an event component consisting of a set of event entries that provide specified records or incidents;
a location component consisting of a set of location entries that provide specified places or areas; and
a time component consisting of a set of time entries that provide specified times or time intervals;
said system making up a three-dimensional query of at least a combination of event, location and time for an associated multi-dimensional information retrieval.

2. The system as claimed in claim 1, said system provides at least one arrangement among said event component, said location component and said time component.

3. The system as claimed in claim 1, wherein said associated multi-dimensional information retrieval includes event search, event view, and event addition/edited, or any one combination of event search, event view, and event addition/edited.

4. The system as claimed in claim 1, said system is associated with a server that supports event search, event view, and event addition/edited.

5. The system as claimed in claim 1, said system allows users to specify tags, or category, or keywords on said event component for a multi-dimensional information retrieval.

6. The system as claimed in claim 1, said system allows users to specify a time period on said time component for a multi-dimensional information retrieval.

7. The system as claimed in claim 1, said system allows users to specify location areas or map areas on said location component for a multi-dimensional information retrieval.

8. The system as claimed in claim 1, said system provides a three-dimensional interface, including event axis, location axis, and time axis.

9. The system as claimed in claim 8, wherein the relative distance on said event axis is the relative distance of both events, which is different in terms of personal interest or individual experience.

10. The system as claimed in claim 8, wherein the relative point on said location axis is the distance relation between two objects, and it gets rid of direction and height.

11. The system as claimed in claim 8, wherein the relative distance on said time axis represents the difference in time directly.

12. The system as claimed in claim 1, said system presents interaction and relation of a three-dimensional information retrieval.

13. The system as claimed in claim 1, wherein blog is one of implementations of said event component, map is one of implementations of said location component, and time-line is one of implementations of said time component.

14. A method for presenting mixed media, comprising:
performing multi-dimensional information retrieval with one or more multimedia blogs or communication platforms; and
making up a three-dimensional query of at least a combination of event, location and time for an associated multi-dimensional information retrieval.

15. The method as claimed in claim 14, said method further includes a step of presenting location information and time information while inquiring a specific interesting event.

16. The method as claimed in claim 15, wherein said location information is one or more specified places or areas, and said time information is one or more specified times or time intervals.

17. The method as claimed in claim 14, said method further includes a step of associating a server to perform any one combination of event search, event view, and event addition/edited.

18. The method as claimed in claim 17, wherein said performing event search further includes:
specifying search condition of at least a combination of event, location and time;
an event component receiving and sending processed result to a time component and a location component; and
loading processed result onto said time component and said location component for further display.

19. The method as claimed in claim 17, wherein said performing event view further includes:
clicking a marker on a time component or a location component to trigger listened events and notify a specified event to an event component;
said event component rendering the event information retrieved from said server, and informing said location component of the event's position and said time component of the event's time period;
adjusting said location component by the event's position and said time component by the event's time period, respectively;
getting the visible bound of said location component and sending a specified location area to said event component, and getting the time from said time component and sending the time period to said event component;
retrieving the events from said server by the specified time period and the specified location area;
sending an event list to said location component and said time component respectively; and
loading corresponding events of said event list onto said time component, or generating and representing marks from corresponding events of said event list onto said location component.

20. The method as claimed in claim 17, wherein said performing event addition/edited further includes:
specifying position on a location component to add event, or adding one or more events on an event component, or editing one or more events on an event component;
said location component getting a specified position and notifying said event component to render the editing view with the specified position;
said event component retrieving a time period from a time component, and setting the time period information; and
inputting event detail information onto said event component, and saving the event detail information in said server.
